(19) United States
(12) Patent Application Publication
(10) Pub. No.: US 2026/0320401 A1
(43) Pub. Date: Oct. 15, 2026

(54) METHODS OF TRAINING AN ARTIFICIAL INTELLIGENCE MODEL FOR OPERATIONAL ANOMALY PREDICTION IN A COMMUNICATIONS NETWORK, AND SYSTEMS

(71) Applicant: NET AI TECH LTD., Edinburgh (GB)

(72) Inventors: Haoyu LIU, Edinburgh (GB); Alec DIALLO, Edinburgh (GB); Samuel KNIGHT, Edinburgh (GB); Marco FIORE, Edinburgh (GB); Paul PATRAS, Edinburgh (GB)

(21) Appl. No.: 19/480,981

(22) PCT Filed: May 2, 2024
(86) PCT No.: PCT/GB2024/051153

§ 371 Date: Nov. 3, 2025

(30) Foreign Application Priority Data
May 2, 2023 (GB) 2306469.4

(51) Int. Cl. G06N 3/09; G06N 3/0442; G06N 3/0455; H04L 41/147; H04L 41/16; H04W 24/04

(52) U.S. Cl. CPC G06N 3/09; G06N 3/0442; G06N 3/0455; H04L 41/147; H04L 41/16; H04W 24/04

(57) ABSTRACT

A computer implemented method of training an artificial intelligence model for operational anomaly prediction in a communications network, comprising: (i) leveraging a data-driven approach to generate in an unsupervised way baselines describing normal daily patterns of performance indicator values, followed by a measure of deviation from the baseline to label each segment of performance indicator values; (ii) using a data augmentation technique that increases both the volume and the variability of anomalous performance indicator values, including taking as input normal/benign time series and randomly scaling them, with a scaling factor sampled from a pre-set uniform distribution; (iii) utilizing a Seq2Seq network to encode the historical data and forecast the future, further fusing the historical information with predicted upcoming performance indicator values; (iv) to achieve both classification and forecasting simultaneously, training the neural models involved with respective first loss functions.

### BACKGROUND OF THE INVENTION

### 1. Field of the Invention

The field of the invention relates to computer implemented methods of generating training data for an artificial intelligence model for operational anomaly prediction in a communications network, to computer implemented methods of training an artificial intelligence model for operational anomaly prediction in a communications network, to computer implemented methods of operational anomaly prediction in a communications network, and to related computer systems.

### 2. Technical Background

Mobile operators currently encounter inefficient infrastructure management and high costs when it comes to hiring specialized engineering staff. As a result, as much as 65.3% of these operators' revenue goes into operating costs, as discussed for example in M. Newman, Global trends in telco OpEx, 2021. Operators face challenges when responding to network performance problems manually, using weak static thresholds and ineffective time granularity. Due to these flaws, service quality is impacted, with failures or misconfigurations not addressed in a timely manner or implemented changes not matching network conditions. Customer churn may be high, as users often feel dissatisfied with their service. Operational anomalies in communications networks may be caused, for example, by equipment failure or radio communication interrupted by weather; by network service outage caused by misconfiguration or an accidentally disconnected network cable; or an external attack where an adversary tries to disable the network. What is needed is improved prediction of operational anomalies in communications networks.

### 3. Discussion of Related Art

EP3346666(A1) and EP3346666(B1) disclose a prediction system configured for modelling the expected number of attacks on a computer or a communication network using data obtained by sensors of an attack monitoring system. The prediction system is capable of modelling the attack rates and predicts the expected number of attacks at different resolutions, granularity levels and horizons. The core modelling module of the system requires basic and minimal information about the observed attacks which makes the prediction system applicable for a variety of attack monitoring systems such as low, medium and high interaction honeypot systems or network telescopes.

EP3357271(A1) and EP3357271(B1) disclose a method for managing a wireless network, comprising: —collecting a sequence of traffic data samples ordered in time, and arranging said collected data samples in at least one level-0 residual matrix having at least one dimension, said dimension of said level-0 residual matrix corresponding to a respective time scale comprising an ordered sequence of time units, said ordered sequences of time units defining a first time window; —performing at least once a cycle, each n-th iteration of the cycle, starting from n=0, comprising a sequence of phases A), B), C), D), E):
A) for at least one dimension of a level-(n) residual matrix, subdividing the corresponding time scale in such a way to group the time units thereof in a respective level-(n+1) partition of time units so as to subdivide the traffic data samples in corresponding level-(n+1) traffic data sample sets;
B) for each level-(n+1) traffic data sample set, calculating a corresponding functional which fits said level-(n+1) traffic data sample set;
C) for each level-(n+1) traffic data sample set, calculating a corresponding approximation of the level-(n+1) traffic data sample set by applying the corresponding functional to the corresponding level-(n+1) partition of time units;
D) joining together the approximations of the level-(n+1) traffic data sample sets to calculate a level-(n+1) approximated matrix, said level-(n+1) approximated matrix being an approximated version of the level-(n) residual matrix;
E) calculating the difference between the level-(n) residual matrix and the calculated level-(n+1) approximated matrix so as to obtain a level-(n+1) residual matrix; —forecasting traffic data trend in a second time window different from the first time window by generating predicted data samples by applying the calculated functional to a partition of time units comprising an ordered sequence of time units corresponding to at least one among said second time window and said first time window; —using said forecasted traffic data trend to manage the wireless network.

### SUMMARY OF THE INVENTION

According to a first aspect of the invention, there is provided a computer implemented method of generating training data for an artificial intelligence model for operational anomaly prediction in a communications network, the method including the steps of:
(i) receiving a communications network historical traffic timeseries which includes one or more performance indicators (e.g. communications network traffic volume, accessibility, physical resource block (PRB) utilisation, call drop rate) as a function of timestamp;
(ii) for each timestamp, computing respective timestamp features denoting relative position in time, e.g. within a year, the month, week of the month, weekday, hour, minute and second;
(iii) generating a function which receives timestamp features as inputs and outputs the closest performance indicator value (e.g. communications network traffic volume, accessibility, physical resource block (PRB) utilisation, call drop rate) at the same time (e.g. the same weekday, the same hour, the same minute and the same second), for any predefined time period (e.g. week) except for the predefined time period (e.g. week) in the input timestamp features;
(iv) using the function generated in (iii), labelling each chunk of the performance indicator (e.g. communications network historical traffic, accessibility, physical resource block (PRB) utilisation, call drop rate) timeseries based on deviation of the chunk from a baseline, e.g. using a Wasserstein distance to measure the deviation using the function generated in (iii); and
(v) storing training data including the label of each chunk of the performance indicator (e.g. communications network historical traffic, accessibility, physical resource block (PRB) utilisation, call drop rate) timeseries.

An advantage is improved training data for an artificial intelligence model for operational anomaly prediction in a communications network.

The method may be one in which the one or more performance indicators is or includes communications network traffic volume, accessibility, physical resource block (PRB) utilisation, or call drop rate.

The method may be one in which the predefined time period is week, hour, or several hours, or a plurality of hours.

The method may be one wherein a baseline is a common profile of the performance indicator of the historical timeseries, that describes how the performance indicator normally evolves over each day, month or year.

The method may be one wherein the baseline is a daily historical average.

The method may be one wherein the baseline is generated by a neural network, e.g. which incorporates some hidden features of the performance indicator timeseries, such as seasonality. An advantage is improved training data for an artificial intelligence model for operational anomaly prediction in a communications network.

The method may be one wherein the function generated in step (iii) is used to produce a baseline.

The method may be one wherein step (iii) includes:
(a) Receiving the timestamp features as inputs and extracting features of the timestamp features, and forwarding the extracted timestamp features to a MLP layer to generate first MLP output, and forwarding the extracted timestamp features to a first FC layer to generate first FC layer output, and forwarding the extracted timestamp features to a second FC layer to generate second FC layer output;
(b) Performing element-wise product transformation on the first MLP output and on the first FC layer output to generate element-wise product output;
(c) Performing element-wise addition transformation on the element-wise product output and on the second FC layer output to generate element-wise addition output;
(d) Inputting the element-wise addition output to the MLP layer to generate second MLP output, and evaluating a (e.g. MAE) loss of the second MLP output compared to performance indicator value (e.g. communications network traffic volume) for the timestamp which corresponds to the timestamp features;
(e) Repeating steps (b) to (d), while modulating the first FC layer and the second FC layer, until a (e.g. MAE) loss minimization criterion is satisfied. An advantage is improved training data for an artificial intelligence model for operational anomaly prediction in a communications network.

The method may be one including storing weights of the first FC layer and of the second FC layer.

The method may be one wherein the MLP layer, the first FC layer and the second FC layer are independent.

The method may be one wherein the modulation is an element-wise affine transformation on the first MLP output.

The method may be one wherein the first FC layer output and the second FC layer output influence the output of the MLP by scaling and shifting each intermediate feature based on the first FC layer input and on the second FC layer input.

The method may be one including constructing a first sample of the training set, the first sample including P steps up to the present of the training set, and repeating for each P; constructing a second sample of the training set, the second sample including a future F steps of the training set, and repeating for each F; identifying a random variable sampled from a uniform distribution, and scaling each pair of the first sample and the second sample using the random variable, to create a scaled set of pairs of the first sample and of the second sample, and performing steps (iv) and (v) on the scaled set of pairs of the first sample and of the second sample, to label each pair of the scaled set of pairs, and to store augmented training data including the label of each pair of the scaled set of pairs. An advantage is improved training data for an artificial intelligence model for operational anomaly prediction in a communications network.

The method may be one wherein the variability of anomalous performance indicator values (e.g. network traffic) from which the neural networks learn is enhanced.

The method may be one wherein the volume and the variability of anomalous traffic is increased.

The method may be one wherein normal/benign time series are input, which are randomly scaled, using a scaling factor sampled from a pre-set uniform distribution.

The method may be one wherein the scaling results in larger deviations from the baseline, and thereby more synthetic anomalies are generated.

According to a second aspect of the invention, there is provided a storage medium storing the training data or the augmented training data of any aspect of the first aspect of the invention.

According to a third aspect of the invention, there is provided a computer implemented method of training an artificial intelligence model for operational anomaly prediction in a communications network, the method including the steps of:
(i) receiving training data including a communications network historical performance indicator timeseries which includes performance indicator values (e.g. communications network traffic volume, accessibility, physical resource block (PRB) utilisation, call drop rate) as a function of timestamp, and a label of each chunk of the communications network historical performance indicator timeseries;
(ii) processing the training data using a positional encoding layer which encodes the timestamp of each datum and fuses that with a corresponding performance indicator value (e.g. communications network traffic volume, accessibility, physical resource block (PRB) utilisation, call drop rate) to produce processed training data;
(iii) encoding the processed training data in a first set of LSTMs as an encoded representation;
(iv) passing the encoded representation to a decoder including a second set of LSTMs which forecasts performance indicator value (e.g. communications network traffic volume, accessibility, physical resource block (PRB) utilisation, call drop rate) of next steps to produce a future performance indicator value forecast;
(v) outputting the encoded representation from the first set of LSTMs via a first FC layer to a first FiLM layer;
(vi) outputting the future performance indicator value forecast from the second set of LSTMs via a second FC layer to a second FILM layer;
(vii) the first FiLM layer fusing the received encoded representation with received input conditional features (e.g. the mean, standard deviation, maximum, minimum, and skewness of the communications network historical performance indicator timeseries) to generate output of the first FiLM layer;
(viii) the second FiLM layer fusing the received future performance indicator value forecast with received target conditional features to generate output of the second FiLM layer;
(ix) concatenating the output of the first FiLM layer and the output of the second FiLM layer to produce a concatenated vector;
(x) evaluating a first (e.g. MSE) loss function of the future performance indicator value forecast compared to actual future performance indicator value, and passing the concatenated vector through a MLP and evaluating the MLP output using a second (e.g. BCE, e.g. including squared error (SE)) loss function which compares predicted labels with ground truth labels, and
(xi) adjusting the first FC layer and the second FC layer while repeating steps (v) to (x) until a convergence criterion with respect to the first loss function and the second loss function is satisfied, to produce a trained model. An advantage is an improved artificial intelligence model for operational anomaly prediction in a communications network.

The method may be one in which the performance indicator is communications network traffic volume, accessibility, physical resource block (PRB) utilisation, or call drop rate.

The method may be one wherein the training data includes training data of any of aspect of the first aspect of the invention, or wherein the training data includes augmented training data of any respective aspect of the first aspect of the invention. An advantage is an improved artificial intelligence model for operational anomaly prediction in a communications network.

The method may be one including storing weights of the trained model.

The method may be one wherein anomaly prediction is treated as a combined task of both classification and forecasting.

The method may be one wherein a prediction is made whether an anomaly will occur (e.g. soon) in the network, while forecasting is also needed since an ‘anomaly’ in our task is defined as a period of performance indicator values (e.g. traffic) that deviates from the baseline, i.e., forecasting the trend of upcoming performance indicator values (e.g. traffic) plays an important role in the decision-making process.

The method may be one wherein a Seq2Seq network is used to encode the historical data and forecast the future performance indicator values (e.g. traffic), further fusing the historical information with predicted upcoming traffic, which is supplied to the final classifier.

The method may be one wherein a Seq2Seq architecture is used, with a stacked LSTM block used as the encoder.

The method may be one wherein to achieve both classification and forecasting simultaneously, the neural models involved are trained with Cross Entropy (CE) and Mean Squared Error (MSE) loss functions, employing a balancing factor.

The method may be one wherein predictions are based on the provided input and the predicted future performance indicator values (e.g. traffic) together.

The method may be one wherein a positional encoding layer is added before the encoder, which encodes the timestamp of each datum and fuses that with the original input.

The method may be one wherein a timestamp is encoded as a d-dimensional vector in which d elements have varying frequencies depending on the index of the vector.

The method may be one wherein conditional features are features obtained solely from the associated timeseries data.

The method may be one wherein FiLM acts as a feature-wise affine transformation on its inputs.

According to a fourth aspect of the invention, there is provided a storage medium storing the weights of the trained model of any aspect of the third aspect of the invention.

According to a fifth aspect of the invention, there is provided a computer system, including a trained artificial intelligence model for operational anomaly prediction in a communications network produced by a method of any aspect of the third aspect of the invention. An advantage is a computer system including an improved artificial intelligence model for operational anomaly prediction in a communications network.

According to a sixth aspect of the invention, there is provided a computer implemented method of operational anomaly prediction in a communications network, including the step of receiving input of performance indicator values (e.g. communications network traffic volume, accessibility, physical resource block (PRB) utilisation, call drop rate) time series data into the computer system including the trained artificial intelligence model for operational anomaly prediction in a communications network of the fifth aspect of the invention, and outputting from the computer system including the trained artificial intelligence model an operational anomaly prediction for the communications network. An advantage is improved operational anomaly prediction in a communications network.

The method may be one in which associations between antennas and upper-level network nodes of the communications network are determined by using a k-partitioning algorithm over a Delaunay graph of antennas.

The method may be one including computing rates for true positive, true negative, false positive and false negative.

According to a seventh aspect of the invention, there is provided a computer implemented method of training an artificial intelligence model for operational anomaly prediction in a communications network, the method including the steps of:
(i) leveraging a data-driven approach to generate in an unsupervised way baselines describing normal daily patterns of performance indicator values (e.g. communications network traffic volume, accessibility, physical resource block (PRB) utilisation, call drop rate), followed by a measure of deviation from the baseline to label each segment of performance indicator values (e.g. communications network traffic volume, accessibility, physical resource block (PRB) utilisation, call drop rate);
(ii) using a data augmentation technique that increases both the volume and the variability of anomalous performance indicator values, including taking as input normal/benign time series and randomly scaling them, with a scaling factor sampled from a pre-set uniform distribution;
(iii) utilizing a Seq2Seq network to encode the historical data and forecast the future, further fusing the historical information with predicted upcoming performance indicator values, which is supplied to the final classifier;
(iv) to achieve both classification and forecasting simultaneously, training the neural models involved with respective first (e.g. Cross Entropy (CE)) and second (e.g. Mean Squared Error (MSE)) loss functions, employing a balancing factor. An advantage is an improved artificial intelligence model for operational anomaly prediction in a communications network.

The method may be one including a method of any aspect of the first aspect of the invention, and/or any aspect of the third aspect of the invention.

According to an eighth aspect of the invention, there is provided a computer system including a trained artificial intelligence model for operational anomaly prediction in a communications network, trained using a method of any aspect of the seventh aspect of the invention. An advantage is a computer system including an improved artificial intelligence model for operational anomaly prediction in a communications network.

According to a ninth aspect of the invention, there is provided a computer implemented method of operational anomaly prediction in a communications network, including the step of receiving input of performance indicator values (e.g. communications network traffic volume, accessibility, physical resource block (PRB) utilisation, call drop rate) time series data into the computer system including the trained artificial intelligence model for operational anomaly prediction in a communications network of the eighth aspect of the invention, and outputting from the computer system including the trained artificial intelligence model an operational anomaly prediction for the communications network. An advantage is improved operational anomaly prediction in a communications network.

Aspects of the invention may be combined.

### BRIEF DESCRIPTION OF THE FIGURES

Aspects of the invention will now be described, by way of example(s), with reference to the following Figures, in which:

FIG. 1 shows an example structure of a baseline generation model. In this Figure, MLP is a multilayer perceptron layer and FC is a fully connected layer; MAE loss is a Mean Absolute Error loss function.

FIG. 2 shows an example structure of a predictive alert model. In this Figure, MLP is a multilayer perceptron layer and FC is a fully connected layer; LSTM is a Long short-term memory network; MSE loss is a Mean Squared Error loss function; BCE is Binary Cross Entropy loss function; SE is Squared Error loss because when computing the loss for a single event, it is just (y−ŷ)\hat{ }2, so there is no need to calculate the mean.

FIG. 3 shows an example of a segment of an actual traffic timeseries and the associated neural network (NN)-generated baseline (dashed line). Black, red, orange and blue represents True Negative (TN), True Positive (TP), False Positive (FP), and False Negative (FN), respectively.

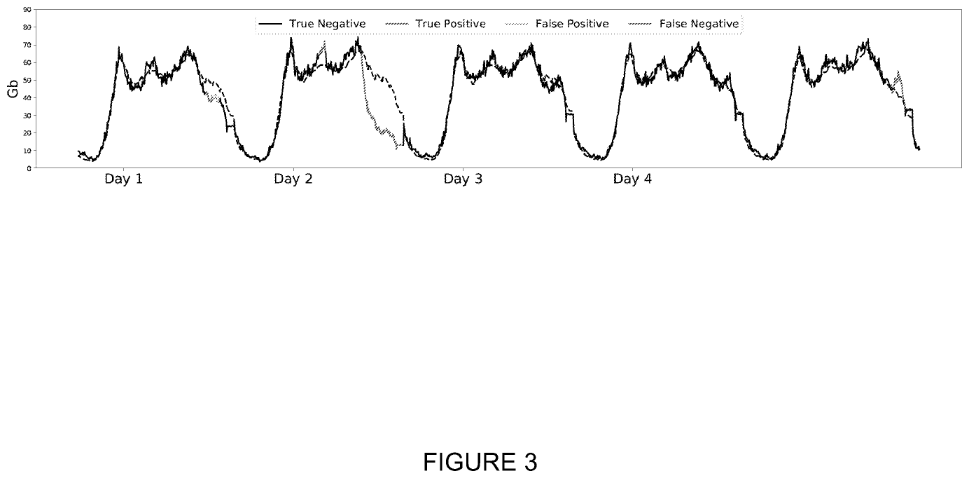

FIG. 4 shows an example of a single FiLM layer for a CNN. The dot signifies a Hadamard product. Various combinations of γ and β can modulate individual feature maps in a variety of ways.

### DETAILED DESCRIPTION

Deep Learning Pipeline for Predictive Operational Anomaly Detection in Communications Networks

Herein, Seq2Seq, or Sequence To Sequence, is a model used in sequence prediction tasks; such models are used in elsewhere in language modelling and/or in machine translation. In an example Seq2Seq, the approach is to use a Long short-term memory (LSTM), the encoder, to read the input sequence one timestep at a time, to obtain a large fixed dimensional vector representation (a context vector), and then to use another LSTM, the decoder, to extract the output sequence from that vector. The second LSTM may be thought of as a recurrent neural network language model except that it is conditioned on the input sequence.

Herein, we refer to a multilayer perceptron (MLP) layer and to a fully connected (FC) layer.

Herein, the Wasserstein distance, sometimes referred to as the Kantorovich-Rubinstein metric, is a distance function defined between probability distributions on a given metric space.

Herein, MEC stands for mobile edge computing; C-RAN stands for cloud radio access network.

In computational geometry, a Delaunay triangulation of a set of points in the plane subdivides their convex hull into triangles whose circumcircles do not contain any of the points. This maximizes the size of the smallest angle in any of the triangles.

Although we state that the timestamps of snapshots can be represented by a list with seconds granularity, the granularity used could be different such as with minutes granularity or hours granularity, as would be clear to the skilled person.

### 1 INTRODUCTION

Problem formulation: Consider an antenna/computing facility that handles traffic generated by a particular service s. The traffic generated by service at the current timestep t is denoted by xₜ. Then xₜ₊₁, xₜ₊₂, . . . , x_{t+F} is the traffic timeseries in the next F steps with a label y_{t~F}∈{0, 1} denoting whether or not the segment of traffic is anomalous. Anomaly prediction seeks to determine the label of the traffic in the upcoming F steps, by leveraging historical information {x_{t-H+1}, x_{t-H+2}, . . . , xₜ}, which is formally expressed as:

$${arg max}_{θ} {p}_{θ} ( {y}_{t \sim F} \vert {x}_{t - H - 1} , {x}_{t - H + 2} , … , {x}_{t} )$$

Traffic anomalies, i.e., the traffic trends that significantly deviate from historical observations are difficult to predict, since they do not follow common periodic patterns and are therefore unlikely to be learned by any machine learning (ML)/deep learning (DL) models directly in a forecasting task. Traditional anomaly detection approaches are themselves unable to solve this particular issue, as they have to observe the actual network traffic, to determine whether anomalies exist; by the time the mobile operator realizes that e.g. an abnormal surge in network traffic has occurred, a Service Level Agreement (SLA) violation may be inevitable.

Solution: To solve this problem, we have developed IdentifAI, a DL-based pipeline that in an example predicts the probability of observing operational network anomalies in the near future, effectively providing insights and a time buffer for mobile operators to manage their networks in advance. The pipeline includes or consists of the following key components:
1. Data Labeling Module: anomalies in time-series data sometimes have various definitions, depending on the degree of deviation of each datum or the persistence of abnormal behaviors. To obtain a clear and unified objective for classification/prediction, we first leverage a data-driven approach to generate in an unsupervised way baselines describing the normal daily patterns of network traffic, followed by a measure of deviation from the baseline to label each segment of network traffic.
2. Anomaly Augmentation Module: Compared with normal traffic, anomalies by their nature only account for a small proportion of samples in a dataset, which poses difficulty for neural models in identifying such occurrences. Traditional techniques, such as oversampling, only alter the proportion of the imbalanced class (anomaly) but does not produce distinct, and potentially new samples. This leads to less-than-desirable detection performance. In an example, we overcome this issue by introducing a data augmentation technique that increases both the volume and the variability of anomalous traffic. Specifically, the module may take as input normal/benign time series and randomly scale them, with a scaling factor sampled from a pre-set uniform distribution. The scaling may result in larger deviations from the baseline, and thereby more synthetic anomalies are generated.
3. Forecasting-aided Seq2Seq Anomaly Prediction Engine: We treat anomaly prediction as a combined task of both classification and forecasting. The classification task is straightforward to understand as the model aims to predict whether anomaly would occur soon in the network, while forecasting is also needed since an ‘anomaly’ in our task is defined as a period of traffic that deviates from the baseline, i.e., forecasting the trend of upcoming traffic plays an important role in the decision-making process. In an example, we utilize a Seq2Seq network to encode the historical data and forecast the future, further fusing the historical information with predicted upcoming traffic, which is supplied to the final classifier.
4. Multi-objective Optimization: To achieve both classification and forecasting simultaneously, we train the neural models involved with Cross Entropy (CE) and Mean Squared Error (MSE) loss functions, employing a balancing factor.

### 2 FRAMEWORK DESIGN

In what follows, we detail the inner working of the IdentifAI framework.

### 2.1 Baseline Generation and Data Labeling

Data labeling is usually based on manual configurations by mobile operators, given that they may particularly attach importance to some abnormal patterns (e.g. persistently low/high traffic volumes, high call drop rates, etc.) over others factors (e.g. network traffic spikes and jitter). However, it is not always straightforward to obtain labels directly from timeseries data without additional support from field technicians. We offer a pure data-driven approach to automated labelling of timeseries data, that includes or consists of two stages, namely, baseline generation and deviation-based labelling.

Baseline Generation. A baseline is considered as a common profile of historical traffic timeseries, that describes how traffic normally evolves over each day, month or year. We generate this baseline by a neural network, which incorporates some hidden features of traffic timeseries, such as seasonality. This can be achieved by approximating a function: bₜ=g(t)∈ [symbol] , which takes as input a timestamp t and outputs the most likely traffic volume at this timestamp, without actually observing it. We first introduce how we generate a dataset ({X, y}) for this function, and then explain why by this approach a neural network that approximates this function can learn a baseline. Assume we have a dataset that logs the traffic volume over M days (where K=M/7 weeks), each data including or consisting of n steps. Then, the timestamps of all the snapshots can be represented by a list with seconds granularity:

$$\{ 0 , \frac{60 \times 60 \times 24}{n} , 2 \times \frac{60 \times 60 \times 24}{n} , … , 60 \times 60 \times 24 \times M \} .$$

For each timestamp sᵢ above we compute the a series of features to describe its relative position in a year, including second (sᵢ mod 60), minute (sᵢ/60 mod 60), hour (sᵢ/(60×60) mod 24), day of a week, week of a month, month, semester and quarter, which becomes the input of a function g(·) at timestamp sᵢ. For target values, we denote the traffic dataset by a K×7×n matrix. At timestep

$${t}_{i}^{k , d}$$

(at week k, day d and step i), the target value is the closest traffic volume at the same step, the same day of a week, in the rest of the weeks, i.e.,

$${y}_{i}^{k , d} = {x}_{i}^{w , d} s . t . , {arg min}_{w} \vert {x}_{i}^{w , d} - {x}_{i}^{k , d} \vert , w ∈ \{ 1 , … , K \} / \{ k \} .$$

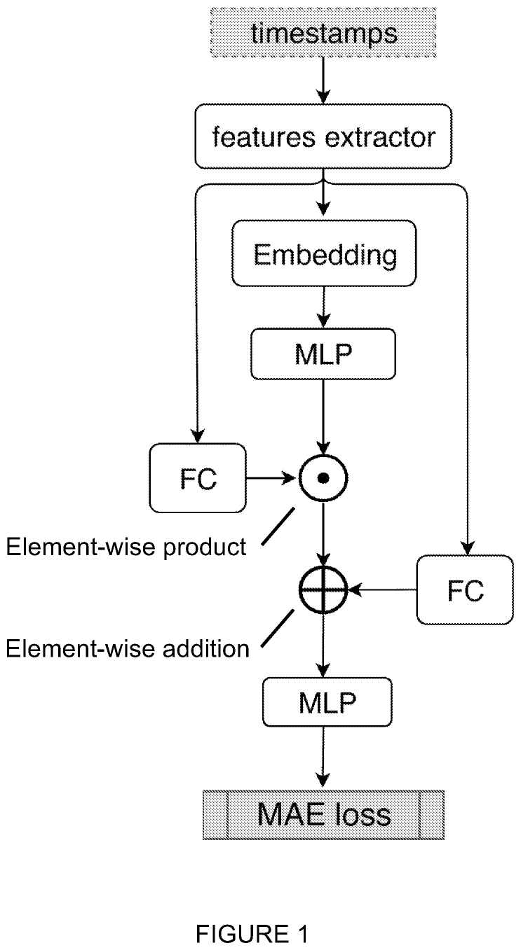

That said, we approximate a function which takes timestamp features as input and outputs the closest data point at the same timestep in the rest of the weeks. It is expected that most of the data are not anomalies so that the closest data point does not differ much from the traffic volume at the target timestep. If the target timestep happens to observe an anomaly, the possibility that the closest data point is also an anomaly is relatively small, avoiding the neural networks from fitting extreme patterns.
We design a baseline generation model, for example as depicted in FIG. 1 to approximate function g(·). In an example, the model receives the timestamp features extracted above as inputs, forwarding to three independent layers (a MLP layer and two FC layers) respectively. Denote the output of the MLP as xₘₗₚ, and the outputs of FC layers as a and b. The network modulates an element-wise affine transformation on xₘₗₚ by a ⊙xₘₗₚ+b. a and b can influence the output of the MLP by scaling and shifting each intermediate feature based on the original input. In this case, the network is more flexible and less likely to be trapped in mediocre local optima during training. This model is optimized with a Mean Absolute Error (MAE) function that minimizes the gap between outputs and target baseline values.

Labeling by Deviation. We label each chunk of timeseries based on how much ‘deviation’ it has from the baseline, which can be defined in several ways. Here, we employ a method based on Wasserstein distance to measure the said ‘deviation’, for which we leverage the daily historical average as the baseline for simplicity.
Denote the chunk of traffic at day i between t+1 and t+F as

$${𝒳}_{t \sim F}^{i} := \{ {x}_{t + 1}^{i} , … {x}_{t + F}^{i} \} .$$

The collection of the same period of traffic across all days in the training data is expressed

$${𝒳}_{t \sim F} := \{ {𝒳}_{t \sim F}^{1} , … , {𝒳}_{t \sim F}^{i} , … , {𝒳}_{t \sim F}^{M} \} .$$

[symbol]

_{t~F} indicates the associated chunk of timeseries in the baseline. Define a function dist(·,·): [symbol] _{F}× [symbol] ^{F}→ [symbol] that measures the Wasserstein distance between two vectors. Applying dist (·, ·) between each chunk in X_{t~F} and [symbol] _{t~F} yields a list of distances:

$${d}_{t \sim F} := \{ {d}_{t \sim F}^{1} , … , {d}_{t \sim F}^{M} \} . {s}_{t \sim F} = \sqrt{( {\sum }_{m = 1}^{M} {( {d}_{t \sim F}^{m} - {\overline{d}}_{t \sim F} )}^{2} ) / M}$$

represents the standard deviation of the distances between actual traffic and the baseline during t+1 ~t+F. Each window of the timeseries is labeled with the following conditional equation:

$${y}_{t \sim F}^{i} = ℒ ( {X}_{t \sim F}^{i} , {ℬ}_{t \sim F} , {s}_{t \sim F} , ϵ ) = \{ \begin{matrix}1 & if {d}_{t \sim F}^{i} > 2 {s}_{t \sim F} and {d}_{t \sim F}^{i} > ϵ , \\ 0 & otherwise\end{matrix} ,$$

$$∀ i ∈ M ,$$

in which ∈ is a global hyperparameter that controls the proportion of anomalies. Note that the standard deviation s_{t~F} is only acquired based on the training data (M days) and used to label test data directly without re-computation.

### 2.2 Anomaly Augmentation

We introduce an anomaly augmentation technique to be used during training, in order to enhance the variability of anomalous traffic from which the neural networks can learn. This is independent from the labeling method introduced previously and flexible in controlling the anomaly ratio in the training set. Denote (X_{t-P~P}, X_{t~F}), y_{t~F} ∈Xₜᵣₐᵢₙ, yₜᵣₐᵢₙ as a sample in the training set, where X_{t-P~P} the input timeseries with P steps, X_{t~F} the future F-step timeseries, and y_{t~F} the label of the future timeseries. Let s~ [symbol] (1−p, 1+p) be a random variable sampled from a uniform distribution. For each (X_{t-P~P}, X_{t~F}) pair, we scale both of them as

\hat{X}_{t-P~P}=x×X_{t-P~P},\tilde{X}_{t~F}=x×X_{t~F},

and re-label the scaled future timeseries chunk by

y_{t~F}= [symbol] (\tilde{X}_{t~F}, [symbol] _{t~F},s_{t~F},∈).

The operation is repeated for every sample in the training set and (\tilde{X}_{t-P~P}, \tilde{X}_{t~F}), \tilde{y}_{t~F} is fed for training instead. Note that s_{t~F} is the standard deviation of the distances computed based on the original traffic. It is potentially more easy to label the scaled timeseries as anomalous, while scaling the input timeseries equally provides the model a relatively consistent view between the past and the future. In practice, we set p=0.5 and find our augmentation technique notably effective.

### 2.3 Anomaly Prediction Engine

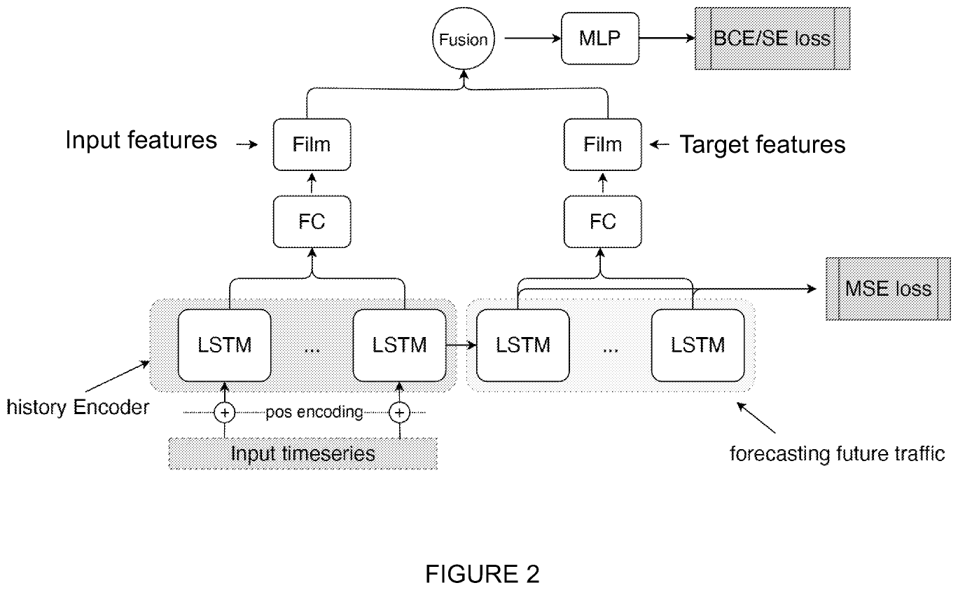

The anomaly prediction engine in IdentifAI leverages a combination of neural networks to achieve accurate predictions of anomalies. Since a label is associated with a chunk of timeseries data instead of a single datum, it is crucial to first forecast the upcoming traffic, and then make predictions based on the provided input and the predicted future traffic together. In our design we build on a Seq2Seq architecture, with a stacked LSTM block used as the encoder, for example as shown in FIG. 2. Different from the simpler architectures, a positional encoding layer is added before the encoder, which encodes the timestamp of each datum and fuses that with the original input. The encoding function is expressed as follows:

PE_{(t,2i)}=sin(t/10000^{2i/d}),

PE_{(t,2i+1)}=cos(t/10000^{2i/d}),

where t is the timestamp of a datum, d the encoded dimension of the timestamp, and i denotes the i-th element in the encoded timestamp. In other words, a timestamp is encoded as a d-dimensional vector in which d elements have varying frequencies depending on the index of the vector. Positional encoding was originally designed for Transformers, which assign order to each word in a sequence. Although LSTM does not struggle with the relative order of data in a sequence, the model has no access to the timestamp of a day wrt. a chunk of input, thus may experience difficulty in telling apart the data captured in the morning and in the evening, where positional encoding can address this issue effectively. The encoded representation is passed to a decoder which forecasts traffic of the next F steps (referred to as ‘output timeseries’ in the rest of this document).

The encoded input and the encoded output timeseries are fed to two FiLM layers respectively, which fuse these with the conditional features. Conditional features in our task are features obtained solely from the associated timeseries data. For example, the mean, standard deviation, maximum, minimum, and skewness of the input timeseries are considered as conditional features of the input. Since these features are highly correlated with the input but less relevant to the output, we leverage the FILM layer to explicitly fuse them with the encoded input timeseries, preventing the model from exploring meaningless relationships between features of the input and the encoded output timeseries. Specifically, denote conditional features of input timeseries as ci, and let ƒ and h be two arbitrary functions that output k dimensional vectors:

γᵢ=ƒ(cᵢ)∈ [symbol] ^{k};βᵢ=h(cᵢ)∈ [symbol] ^{k}.

Let Fᵢ ∈ [symbol] ^{k} be an intermediate representation of the input timeseries in k-dimensional space. FiLM acts as a feature-wise affine transformation on Fᵢ via:

FiLM(Fᵢ|γᵢ,βᵢ)=γᵢ⊙Fᵢ+βᵢ,

where ⊙ represents element-wise product. FiLM is also applied to the encoded output timeseries, followed by a concatenation of two FiLM outputs. In an example, target features are computed in the same way as input features, with the difference being that target features are derived from predicted, future timeseries data, whereas input features from historical timeseries. The concatenated vector includes or consists of not only historical information, but also predicted future information for the final classification.

### 2.4 Loss Functions

In an example, to train this model, we adopt two loss functions simultaneously. Denote \hat{x}_{t~F}={\hat{x}₊₁, \hat{x}ₜ₊₂, . . . , \hat{x}_{+F}} as the predicted future traffic and x_{t~F}={xₜ₊₁, xₜ₊₂, . . . , x_{t+F}} the actual future traffic. The Seq2Seq part of the model is trained with a Mean Squared Error (MSE) function:

$${L}_{m s e} ( {\hat{x}}_{t \sim F} , {x}_{t \sim F} ) = \frac{{\sum }_{t}^{F} {( {\hat{x}}_{t} - {x}_{t} )}^{2}}{F} .$$

Let ŷ_{t~F}∈[0, 1] be the predicted label and y_{t~F} ∈{0, 1} the ground truth label. The entire model including the Seq2Seq part is trained via Binary Cross Entropy (BCE) for the classification task:

L_{bce}(ŷ_{t~F},y_{t~F})=y_{t~F} log(ŷ_{t~F})+(1−y_{t~F})log(1−ŷ_{t~F})

### 3 PRELIMINARY EVALUATIONS

### 3.1 Datasets

We evaluated our model on two large-scale real-world mobile network datasets collected in two major European cities, each representative of deployments with over 700 antennas, and monitoring over 20 mobile services.
To evaluate the performance of our model under different network architectures, we consider three extra cases apart from antenna-level analyses: (1) 50 MEC facilities deployed at the edge handling traffic between 10-20 antennas; (2) 30 C-RAN datacenters, handling the traffic from 20-40 antennas; (3) 10 core datacenters (DC) handling the traffic from over 50 antennas. Following the approach in C. Zhang, M. Fiore, and P. Patras, “Multi-service mobile traffic forecasting via convolutional long short-term memories,” IEEE International Symposium on Measurements & Networking (M&N), 2019, we determine the associations between antennas and upper-level network nodes by using a k-partitioning algorithm over the Delaunay graph of antennas.
We keep weekday traffic in both datasets for evaluations due to the distinct temporal patterns that exist over weekends. Predicting anomalies for weekend traffic is possible but requires a dataset over a longer time span for acceptable performance. We further split weekday traffic into a training set (40 days) and a test set (15/20 days).

### 3.2 Evaluation Metrics

We formulate anomaly prediction as a classification task and therefore use F1 score as the evaluation metric, defined as:

$$F 1 = 2 \times \frac{precision \times recall}{precision + recall} ,$$

where precision=TP/(TP+FP) and recall=TP/(TP+FN). F1 score computes the harmonic mean between precision and recall. The former represents how likely an algorithm would give true alarms, and the latter indicates how sensitive an algorithm is towards positive samples. Additionally, mobile operators may be concerned about the False Positive Rate, FPR=FP/(FP+TN). A high FPR could result in a waste of resources as every predicted positive instance needs to be checked by on-site engineers. Conversely, the False Negative Rate is defined as FNR=1−recall.

### 3.3 Efficacy of Data Augmentation

We demonstrate that our data augmentation technique improves performance, with regard to all evaluation metrics considered, on both datasets at multiple clustering levels. Table 1 compares the metrics achieved with and without using data augmentation. On average, data augmentation results in an average F1 score increase of 10%.

TABLE 1
The average Precision, Recall, F1 scores and FPR of our model on two datasets with/without
the anomaly augmentation technique applied. The anomalies are labeled with NN-generated
baseline and the distance-based method.

| | | without augmentation | | | | with augmentation | | | |
|---|---|---|---|---|---|---|---|---|---|
| | Network | | | | FPR | | | | FNR |
| Dataset | Level | Precision | Recall | F1 | (%) | Precision | Recall | F1 | (%) |
| City 1 | DC | 0.828 | 0.763 | 0.79 | 3.0 | 0.872 | 0.878 | 0.874 | 4.1 |
| | CRAN | 0.808 | 0.487 | 0.601 | 3.1 | 0.793 | 0.823 | 0.807 | 6.1 |
| | MEC | 0.701 | 0.473 | 0.547 | 4.7 | 0.794 | 0.779 | 0.786 | 5.4 |
| | antenna | 0.414 | 0.177 | 0.235 | 5.0 | 0.481 | 0.423 | 0.448 | 6.4 |
| City 2 | DC | 0.762 | 0.554 | 0.632 | 3.0 | 0.757 | 0.714 | 0.731 | 3.7 |
| | CRAN | 0.718 | 0.477 | 0.562 | 4.6 | 0.682 | 0.643 | 0.658 | 6.5 |
| | MEC | 0.646 | 0.479 | 0.541 | 4.5 | 0.679 | 0.633 | 0.652 | 4.9 |
| | antenna | 0.379 | 0.260 | 0.302 | 7.6 | 0.392 | 0.434 | 0.405 | 12.0 |

### 4 Feature-Wise Linear Modulation (FILM)

FiLM stands for Feature-wise Linear Modulation. The reference E. Perez, F. Strub, H. de Vries, V. Dumoulin, and A. Courville, “Film: Visual reasoning with a general conditioning layer,” 2017 is referred to.

FiLM is a general-purpose conditioning method for neural networks. FiLM layers influence neural network (NN) computation via a simple, feature-wise affine transformation based on conditioning information. A FILM layer carries out a simple, feature-wise affine transformation on a neural network's intermediate features, conditioned on an arbitrary input. FILM layers may enable a Recurrent Neural Network (RNN) over an input question to influence a Convolutional Neural Network (CNN) computation. This process may adaptively and radically alter the CNN's behavior as a function of the input question, allowing the overall model to carry out a variety of reasoning tasks, ranging from counting to comparing, for example.

FiLM operates in a coherent manner. It learns a complex, underlying structure and manipulates the conditioned network's features in a selective manner. It also enables the CNN to properly localize question-referenced objects.

FiLM models may learn from little data to generalize to more complex and/or substantially different data than seen during training.

FiLM learns to adaptively influence the output of a neural network by applying an affine transformation, or FiLM, to the network's intermediate features, based on some input. More formally, FiLM learns functions ƒ and h which output y and β as a function of input. ƒ and h can be arbitrary functions such as neural networks. Modulation of a target neural network's processing can be based on the same input to that neural network or some other input, as in the case of multi-modal or conditional tasks.

As FiLM only requires two parameters per modulated feature map, it is a scalable and computationally efficient conditioning method.

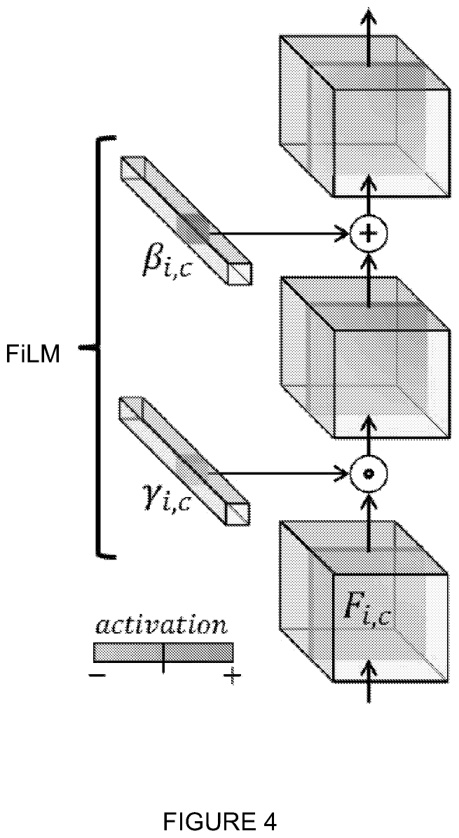

FIG. 4 shows an example of a single FiLM layer for a CNN.

### NOTE

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1.-18. (canceled)

19. A computer implemented method of training an artificial intelligence model for operational anomaly prediction in a communications network, the method including the steps of:
(i) receiving training data including a communications network historical performance indicator timeseries which includes performance indicator values (e.g. communications network traffic volume, accessibility, physical resource block (PRB) utilisation, call drop rate) as a function of timestamp, and a label of each chunk of the communications network historical performance indicator timeseries;
(ii) processing the training data using a positional encoding layer which encodes the timestamp of each datum and fuses that with a corresponding performance indicator value (e.g. communications network traffic volume, accessibility, physical resource block (PRB) utilisation, call drop rate) to produce processed training data;
(iii) encoding the processed training data in a first set of LSTMs as an encoded representation;
(iv) passing the encoded representation to a decoder including a second set of LSTMs which forecasts performance indicator value (e.g. communications network traffic volume, accessibility, physical resource block (PRB) utilisation, call drop rate) of next steps to produce a future performance indicator value forecast;
(v) outputting the encoded representation from the first set of LSTMs via a first FC layer to a first FiLM layer;
(vi) outputting the future performance indicator value forecast from the second set of LSTMs via a second FC layer to a second FiLM layer;
(vii) the first FiLM layer fusing the received encoded representation with received input conditional features (e.g. the mean, standard deviation, maximum, minimum, and skewness of the communications network historical performance indicator timeseries) to generate output of the first FiLM layer;
(viii) the second FiLM layer fusing the received future performance indicator value forecast with received target conditional features to generate output of the second FiLM layer;
(ix) concatenating the output of the first FiLM layer and the output of the second FILM layer to produce a concatenated vector;
(x) evaluating a first (e.g. MSE) loss function of the future performance indicator value forecast compared to actual future performance indicator value, and passing the concatenated vector through a MLP and evaluating the MLP output using a second (e.g. BCE, e.g. including squared error (SE)) loss function which compares predicted labels with ground truth labels, and
(xi) adjusting the first FC layer and the second FC layer while repeating steps (v) to (x) until a convergence criterion with respect to the first loss function and the second loss function is satisfied, to produce a trained model.

20. The method of claim 19, in which the performance indicator is communications network traffic volume, accessibility, physical resource block (PRB) utilisation, or call drop rate.

21. The method of claim 19, wherein the training data includes training data produced using a computer implemented method of generating training data for an artificial intelligence model for operational anomaly prediction in a communications network, the method including the steps of:
(i) receiving a communications network historical timeseries which includes one or more performance indicators (e.g. communications network traffic volume, accessibility, physical resource block (PRB) utilisation, call drop rate) as a function of timestamp;
(ii) for each timestamp, computing respective timestamp features denoting relative position in time, e.g. within a year, the month, week of the month, weekday, hour, minute and second;
(iii) generating a function which receives timestamp features as inputs and outputs the closest performance indicator value (e.g. communications network traffic volume, accessibility, physical resource block (PRB) utilisation, call drop rate) at the same time (e.g. the same weekday, the same hour, the same minute and the same second), for any predefined time period (e.g. week) except for the predefined time period (e.g. week) in the input timestamp features;
(iv) using the function generated in (iii), labelling each chunk of the performance indicator (e.g. communications network historical traffic, accessibility, physical resource block (PRB) utilisation, call drop rate) timeseries based on deviation of the chunk from a baseline, e.g. using a Wasserstein distance to measure the deviation using the function generated in (iii); and
(v) storing training data including the label of each chunk of the performance indicator (e.g. communications network historical traffic, accessibility, physical resource block (PRB) utilisation, call drop rate) timeseries.

22. The method of claim 19, including storing weights of the trained model.

23. The method of claim 19, wherein anomaly prediction is treated as a combined task of both classification and forecasting.

24. The method of claim 19, wherein a prediction is made whether an anomaly will occur (e.g. soon) in the network, while forecasting is also needed since an ‘anomaly’ in our task is defined as a period of performance indicator values (e.g. traffic) that deviates from the baseline, i.e., forecasting the trend of upcoming performance indicator values (e.g. traffic) plays an important role in the decision-making process.

25. The method of claim 19, wherein a Seq2Seq network is used to encode the historical data and forecast the future performance indicator values (e.g. traffic), further fusing the historical information with predicted upcoming performance indicator values (e.g. traffic), which is supplied to the final classifier.

26. The method of claim 19, wherein a Seq2Seq architecture is used, with a stacked LSTM block used as the encoder.

27. The method of claim 19, wherein to achieve both classification and forecasting simultaneously, the neural models involved are trained with Cross Entropy (CE) and Mean Squared Error (MSE) loss functions, employing a balancing factor.

28. The method of claim 19, wherein predictions are based on the provided input and the predicted future performance indicator values (e.g. traffic) together.

29. The method of claim 19, wherein a positional encoding layer is added before the encoder, which encodes the timestamp of each datum and fuses that with the original input.

30. The method of claim 19, wherein a timestamp is encoded as a d-dimensional vector in which d elements have varying frequencies depending on the index of the vector.

31. The method of claim 19, wherein conditional features are features obtained solely from the associated timeseries data.

32. The method of claim 19, wherein FILM acts as a feature-wise affine transformation on its inputs.

33. (canceled)

34. A computer system, including a trained artificial intelligence model for operational anomaly prediction in a communications network produced by a computer implemented method training an artificial intelligence model for operational anomaly prediction in a communications network, the method including the steps of:
(i) receiving training data including a communications network historical performance indicator timeseries which includes performance indicator values (e.g. communications network traffic volume, accessibility, physical resource block (PRB) utilisation, call drop rate) as a function of timestamp, and a label of each chunk of the communications network historical performance indicator timeseries;
(ii) processing the training data using a positional encoding layer which encodes the timestamp of each datum and fuses that with a corresponding performance indicator value (e.g. communications network traffic volume, accessibility, physical resource block (PRB) utilisation, call drop rate) to produce processed training data;
(iii) encoding the processed training data in a first set of LSTMs as an encoded representation;
(iv) passing the encoded representation to a decoder including a second set of LSTMs which forecasts performance indicator value (e.g. communications network traffic volume, accessibility, physical resource block (PRB) utilisation, call drop rate) of next steps to produce a future performance indicator value forecast;
(v) outputting the encoded representation from the first set of LSTMs via a first FC layer to a first FiLM layer;
(vi) outputting the future performance indicator value forecast from the second set of LSTMs via a second FC layer to a second FiLM layer;
(vii) the first FiLM layer fusing the received encoded representation with received input conditional features (e.g. the mean, standard deviation, maximum, minimum, and skewness of the communications network historical performance indicator timeseries) to generate output of the first FiLM layer;
(viii) the second FiLM layer fusing the received future performance indicator value forecast with received target conditional features to generate output of the second FiLM layer;
(ix) concatenating the output of the first FiLM layer and the output of the second FILM layer to produce a concatenated vector;
(x) evaluating a first (e.g. MSE) loss function of the future performance indicator value forecast compared to actual future performance indicator value, and passing the concatenated vector through a MLP and evaluating the MLP output using a second (e.g. BCE, e.g. including squared error (SE)) loss function which compares predicted labels with ground truth labels, and
(xi) adjusting the first FC layer and the second FC layer while repeating steps (v) to (x) until a convergence criterion with respect to the first loss function and the second loss function is satisfied, to produce the trained model.

35. Computer implemented method of operational anomaly prediction in a communications network, including the step of receiving input of performance indicator values (e.g. communications network traffic volume, accessibility, physical resource block (PRB) utilisation, call drop rate) time series data into a computer system including a trained artificial intelligence model for operational anomaly prediction in the communications network, and outputting from the computer system including the trained artificial intelligence model an operational anomaly prediction for the communications network, wherein the computer system, including the trained artificial intelligence model for operational anomaly prediction in the communications network, is produced by a computer implemented method of training the artificial intelligence model for operational anomaly prediction in the communications network, the method including the steps of:
(i) receiving training data including a communications network historical performance indicator timeseries which includes performance indicator values (e.g. communications network traffic volume, accessibility, physical resource block (PRB) utilisation, call drop rate) as a function of timestamp, and a label of each chunk of the communications network historical performance indicator timeseries;
(ii) processing the training data using a positional encoding layer which encodes the timestamp of each datum and fuses that with a corresponding performance indicator value (e.g. communications network traffic volume, accessibility, physical resource block (PRB) utilisation, call drop rate) to produce processed training data;
(iii) encoding the processed training data in a first set of LSTMs as an encoded representation;
(iv) passing the encoded representation to a decoder including a second set of LSTMs which forecasts performance indicator value (e.g. communications network traffic volume, accessibility, physical resource block (PRB) utilisation, call drop rate) of next steps to produce a future performance indicator value forecast;
(v) outputting the encoded representation from the first set of LSTMs via a first FC layer to a first FiLM layer;
(vi) outputting the future performance indicator value forecast from the second set of LSTMs via a second FC layer to a second FiLM layer;
(vii) the first FiLM layer fusing the received encoded representation with received input conditional features (e.g. the mean, standard deviation, maximum, minimum, and skewness of the communications network historical performance indicator timeseries) to generate output of the first FiLM layer;
(viii) the second FiLM layer fusing the received future performance indicator value forecast with received target conditional features to generate output of the second FiLM layer;
(ix) concatenating the output of the first FiLM layer and the output of the second FILM layer to produce a concatenated vector;
(x) evaluating a first (e.g. MSE) loss function of the future performance indicator value forecast compared to actual future performance indicator value, and passing the concatenated vector through a MLP and evaluating the MLP output using a second (e.g. BCE, e.g. including squared error (SE)) loss function which compares predicted labels with ground truth labels, and
(xi) adjusting the first FC layer and the second FC layer while repeating steps (v) to (x) until a convergence criterion with respect to the first loss function and the second loss function is satisfied, to produce the trained model.

36. The method of claim 35, in which associations between antennas and upper-level network nodes of the communications network are determined by using a k-partitioning algorithm over a Delaunay graph of antennas.

37. The method of claim 35, including computing rates for true positive, true negative, false positive and false negative.

38-41. (canceled)

42. The method of claim 20, wherein the training data includes training data produced using a computer implemented method of generating training data for an artificial intelligence model for operational anomaly prediction in a communications network, the method including the steps of:
(i) receiving a communications network historical timeseries which includes one or more performance indicators (e.g. communications network traffic volume, accessibility, physical resource block (PRB) utilisation, call drop rate) as a function of timestamp;
(ii) for each timestamp, computing respective timestamp features denoting relative position in time, e.g. within a year, the month, week of the month, weekday, hour, minute and second;
(iii) generating a function which receives timestamp features as inputs and outputs the closest performance indicator value (e.g. communications network traffic volume, accessibility, physical resource block (PRB) utilisation, call drop rate) at the same time (e.g. the same weekday, the same hour, the same minute and the same second), for any predefined time period (e.g. week) except for the predefined time period (e.g. week) in the input timestamp features;
(iv) using the function generated in (iii), labelling each chunk of the performance indicator (e.g. communications network historical traffic, accessibility, physical resource block (PRB) utilisation, call drop rate) timeseries based on deviation of the chunk from a baseline, e.g. using a Wasserstein distance to measure the deviation using the function generated in (iii); and
(v) storing training data including the label of each chunk of the performance indicator (e.g. communications network historical traffic, accessibility, physical resource block (PRB) utilisation, call drop rate) timeseries.

43. The method of claim 36, including computing rates for true positive, true negative, false positive and false negative.
